(19) United States
(12) Patent Application Publication
(10) Pub. No.: US 2019/0175437 A1
(43) Pub. Date: Jun. 13, 2019

(54) DOUBLE FOAM ROLLER DEVICE AND METHOD OF USE

(71) Applicant: Greg H. Blessing, Arlington, TX (US)

(72) Inventor: Greg H. Blessing, Arlington, TX (US)

(21) Appl. No.: 16/214,066

(22) Filed: Dec. 8, 2018

Related U.S. Application Data
(60) Provisional application No. 62/596,475, filed on Dec. 8, 2017.

(51) Int. Cl. A61H 15/00

(52) U.S. Cl. CPC A61H 15/00; A61H 2015/0014

(57) ABSTRACT

A double foam roller device includes a first foam roller; a second foam roller; and two adjustable arms to extend from the first foam roller to the second foam roller; the first foam roller and second foam roller are secured at a distance, and the distance is adjustable via the two adjustable arms.

### BACKGROUND

### 1. Field of the Invention

The present invention relates generally to foam rollers for use before, during, or after exercise, and more specifically, to a double foam roller device for improved muscle massage and tension release.

### 2. Description of Related Art

Foam rollers are well known in the art and are effective means to massage and release tension from muscles, either after exercise or at any time when such tension release is desired. Conventional foam rollers are single rolling devices allowing for the user to massage one area of their body at a time. It is thus desirable to have a foam roller device with two rollers separated by adjustable arms, allowing for adjustment of the separation of the rollers.

Accordingly, although great strides have been made in the area of foam rollers, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an oblique view of a double foam roller device in accordance with a preferred embodiment of the present application;

FIG. 2 is an exploded view of the double foam roller device of FIG. 1;

FIG. 3 is a flowchart of the method of use of the foam roller device of FIG. 1; and

FIG. 4 is an exploded view of an alternative embodiment of a double foam roller device in accordance with the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional foam rollers. Specifically, the present invention provides a device having two foam rollers separated by adjustable arms. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

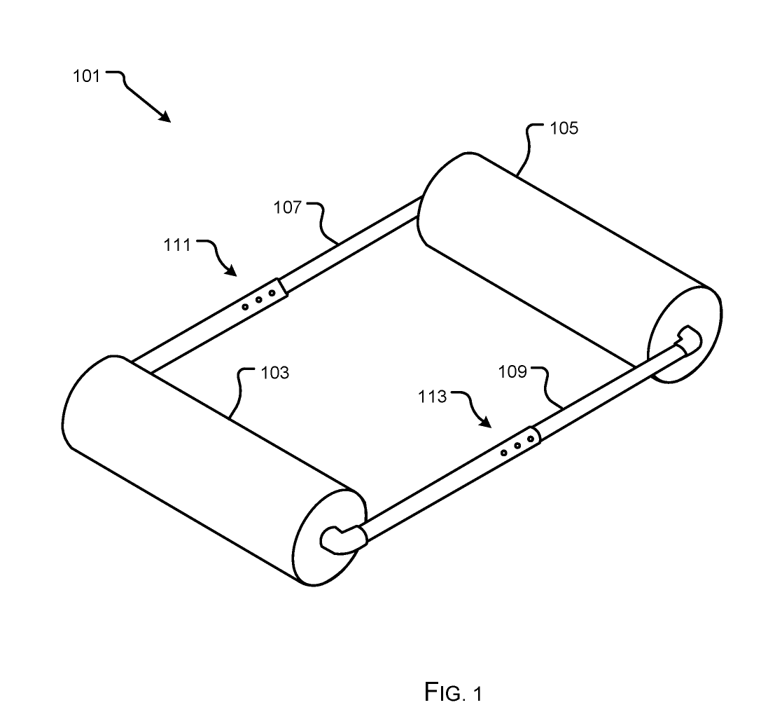

Referring now to the drawings wherein like reference characters identify corresponding or similar elements throughout the several views, FIG. 1 depicts an oblique view of a double foam roller device 101 in accordance with a preferred embodiment of the present application. It will be appreciated that device 101 overcomes one or more of the above-listed problems commonly associated with conventional foam rollers.

In the contemplated embodiment, device 101 includes at least two foam rollers 103, 105 attached via two adjustable arms 107, 109, having adjustment means 111, 113 allowing for the user to further separate foam rollers 103, 105. It should be appreciated that the overall size and dimensions of the various components of device 101 can vary as aesthetical, functional, or manufacturing considerations require. In addition, it should be appreciated that the foam rollers 103, 105 can vary in soft, pliable materials, and can include surface features, such as ridges, bumps, protrusions, or the like, thereby aiding in muscle tension relaxation.

In an alternative embodiment, it is contemplated that device 101 can include joints positioned near a center of each arm, the joints being configured to allow for the device to fold into a substantially compact position.

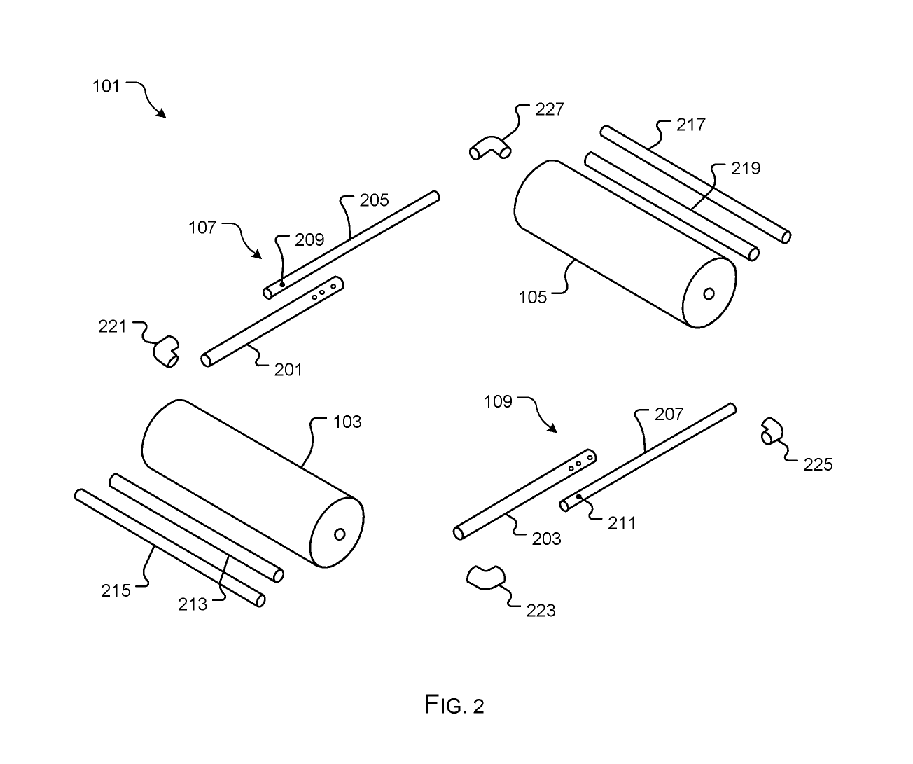

In FIG. 2, an exploded view further demonstrates the components of device 101. Device 101 includes foam rollers 103, 105 and arms 107, 109, wherein each of the arms further comprises a first portion 201, 203 and a second portion 205, 207 configured to be slidingly engaged with first portions 201, 203, thereby allowing for adjustability via a depressible button 209, 211. It should be appreciated that any other appropriate adjustment means could be used in alternative embodiments. Arms 107, 109 are engaged with one or more rods 213, 215, 217, 219, via one or more elbows 221, 223, 225, 227, the one or more rods configured to be inserted through a center of each of the foam rollers 103, 105 to allow the foam rollers to roll.

It should be appreciated that one of the unique features believed characteristic of the present application is the use of two foam rollers attached via adjustable arms.

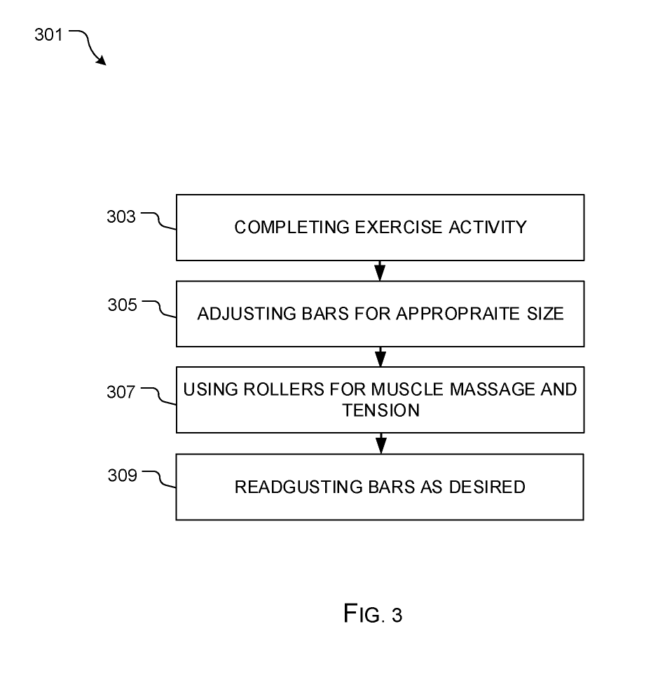

In FIG. 3, a flowchart 301 depicts a method of use of device 101. During use, either after the user exercises or at any time that the user desires, the device is adjusted to the appropriately desired width, as shown with boxes 303, 305. The user proceeds to use both rollers, typically one on the upper body such as the back, and one on the legs, to release muscle tension, as shown with box 307. As desired, the user readjusts the arms to a second width, and repeats use of the device, as shown with box 309.

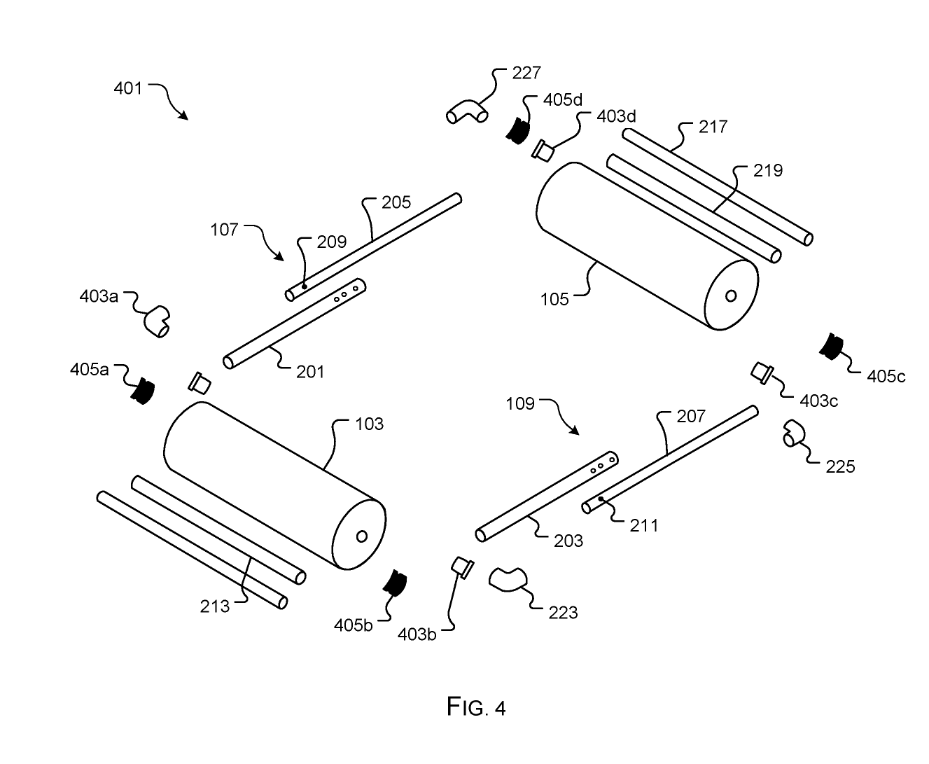

In FIG. 4, an alternative embodiment of a foam roller device 401 is shown. Device 401 includes all of the features discussed above, but can further include one or more PVC bushings 403 and one or more threaded extension knobs 401. These features can ensure that the device is secured together properly.

It should be appreciated that the system of the present invention can vary in size, and materials as aesthetical, functional, or manufacturing considerations require.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A double foam roller device, comprising:
a first foam roller;
a second foam roller; and
two adjustable arms configured to extend from the first foam roller to the second foam roller;
wherein the first foam roller and second foam roller are secured at a distance, and wherein the distance is adjustable via the two adjustable arms.

2. The device of claim 1, wherein the two adjustable each further comprise:
a first portion slidingly engaged with a second portion to create adjustability.

3. The device of claim 1, further comprising:
a first rod configured to extend through a center of the first foam roller and engage with the two arms at a right angle; and
a second rod configured to extend through a center of the second foam roller and engage with the two arms at right angle.
